(19) United States
(12) Patent Application Publication
(10) Pub. No.: US 2025/0138572 A1
(43) Pub. Date: May 1, 2025

(54) CLOCK CONTROL SCHEME, METHODS AND CIRCUITS THEREFOR

(71) Applicant: Arm Limited, Cambridge (GB)

(72) Inventors: Amit Chhabra, Noida (IN); Rainer Herberholz, Great Abington (GB); Peter Andrew Rees Williams, Great Abington (GB); Stuart James Aitken, Cambridge (GB); Sarah Jean Kimber, Sheffield (GB)

(73) Assignee: Arm Limited, Cambridge (GB)

(21) Appl. No.: 18/925,491

(22) Filed: Oct. 24, 2024

(30) Foreign Application Priority Data
Oct. 27, 2023 (IN) 202311073432
Mar. 20, 2024 (GB) 2403979.4

(51) Int. Cl. G06F 1/08; G06F 1/10

(52) U.S. Cl. CPC G06F 1/08; G06F 1/10

(57) ABSTRACT

The present techniques relate to a clock control scheme(s) and discloses circuitry for providing a clock signal to a sub-system of a processor, the circuitry comprising: a first clock selection stage to receive clock signals from a plurality of clock sources and, responsive to one or more first control signals, provide first and second clock signals to a second selection stage; a second selection component at the second selection stage to, responsive to one or more second control signals, select one of the first and second clock signals and output the selected clock signal as a mitigated clock signal.

### TECHNICAL FIELD

The present techniques relate to clock control scheme and related methods and circuitry in a system comprising one or more processor cores. In particular, the present techniques relate to a clock control scheme, related methods and circuitry therefor in a multi core system.

### BACKGROUND OF THE DISCLOSURE

Some computer units (e.g. a central processor unit (CPU) or graphics processor unit (GPU)) may experience performance issues. For example, a CPU can generate voltage droops due to large changes in current required from a power delivery network (PDN).

There is a need for mitigation action to address such performance issues.

### SUMMARY OF THE DISCLOSURE

The present techniques relate to addressing or mitigating such performance issues or improving known mitigation techniques.

According to a first aspect, there is provided circuitry for providing a clock signal to a sub-system of a processor, the circuitry comprising: a first clock selection stage to receive clock signals from a plurality of clock sources and, responsive to one or more first control signals, provide first and second clock signals to a second selection stage; a second selection component at the second selection stage to, responsive to one or more second control signals, select one of the first and second clock signals and provide the selected clock signal as a mitigated clock signal to a modulator stage; a plurality of modulator units at the modulator stage to, responsive to one or more modulation signals, modulate the mitigated clock signal and provide the modulated clock signal to the subsystem.

According to a further aspect there is provided circuitry for providing a clock signal to a sub-system of a processor, the circuitry comprising: a first clock selection stage to receive clock signals from a plurality of clock sources and, responsive to one or more first control signals, provide first and second clock signals to a second selection stage; a second selection component at the second selection stage to, responsive to one or more second control signals, select one of the first and second clock signals and the selected clock signal as a mitigated clock signal. In an embodiment, the circuitry comprises a modulator stage, the modulator stage comprising a plurality of modulator units to, responsive to one or more modulation signals, modulate the mitigated clock signal and provide the modulated clock signal to the subsystem.

The first selection component may be controlled responsive to control signals from a first state machine, where the properties of the control signals from the first state machine may be defined by a second state machine and the second selection component may be controlled responsive to control signals from the second and/or a third state machine. The properties of the control signals from the second and/or third state machine may be dependent on a detected first event.

The detected first event may comprise a voltage droop event.

A modulator unit of the plurality of modulator units may be operable to modulate the mitigated clock signal and provide the modulated clock signal to the subsystem responsive to modulator signals received thereat.

The modulator unit may modulate the mitigated clock signal by one or more of: changing the frequency of the mitigated clock signal; and suppressing one or more of the clock pulses of the mitigated clock signal.

A first modulator signal received at the modulator unit may define a denominator value and where a second modulator signal received at the modulator unit may define a numerator value, where the numerator value provided to the modulator unit may be controlled by a fourth state machine responsive to a second event. The second event may comprise a pre-over-current warning.

The modulator unit may provide the modulated clock signal to an associated processor core.

In an embodiment, the plurality of clock sources may be phase locked looped (PLL), where the properties of the PLL clock sources may be configured by the first state machine.

The first clock signal provided to the second selection stage may comprise a nominal clock signal and where the second clock signal provided to the second selection stage may comprise a fallback clock signal.

According to a further aspect there is provided a state machine comprising circuitry for providing a clock signal to a sub-system of a processor, the circuitry comprising: a first clock selection stage to receive clock signals from a plurality of clock sources and, responsive to one or more first control signals, provide first and second clock signals to a second selection stage; a second selection component at the second selection stage to, responsive to one or more second control signals, select one of the first and second clock signals and provide the selected clock signal as a mitigated clock signal to a modulator stage; a plurality of modulator units at the modulator stage to, responsive to one or more modulation signals, modulate the mitigated clock signal and provide the modulated clock signal to the subsystem.

According to a further aspect there is provided a state machine comprising circuitry for providing a clock signal to a sub-system of a processor, the circuitry comprising: a first clock selection stage to receive clock signals from a plurality of clock sources and, responsive to one or more first control signals, provide first and second clock signals to a second selection stage; a second selection component at the second selection stage to, responsive to one or more second control signals, select one of the first and second clock signals and output the selected clock signal as a mitigated clock signal. The state machine may further comprise a modulator stage having a plurality of modulator units, and where each of the plurality of modulator units is to, responsive to one or more modulation signals, modulate the mitigated clock signal and provide the modulated clock signal to the subsystem.

The state machine may comprise a first state machine to define the properties of the one or more first control signals, where the first state machine may define the properties of the one or more first control signals responsive to dynamic voltage and frequency scaling operations.

A second state machine may define properties of the control signals from the first state machine. A third state machine may define the properties of the one or more second control signals responsive to a droop event. In an embodiment, a fourth state machine may define the properties of the one or more modulation signals responsive to a signal from a power management circuit.

One or more of the first, second, third and fourth state machines may define the properties of the respective selection or modulation signals responsive to the values stored in one or more registers.

The circuitry and the second state machine may be in a first voltage domain, where the first voltage domain undergoes a change in voltage level during a DVFS operation or sequence executed by the second state machine. The first and third state machines may be in a second voltage domain, where the second voltage domain substantially maintains the voltage level during the DVFS operation or sequence executed by the state machine.

In an embodiment, control signals provided by components in the first voltage domain to components in the second voltage domain may be level-shifted to the voltage of the second domain.

According to a further aspect, there is provided a method of providing a clock signal to a sub-system of a processor, the method comprising: receiving, at a first clock selection stage, clock signals from a plurality of clock sources; providing, from the first clock selection stage, first and second clock signals to a second selection stage responsive to one or more first control signals; selecting, at the second clock selection stage, one of the first and second clock signals responsive to one or more second control signals; providing, from the second selection stage, the selected clock signal as a mitigated clock signal to a modulator stage responsive, modulating, at a modulator unit, the mitigated clock signal responsive to one or more modulation signals; providing, from the modulator unit, the modulated clock signal to the subsystem.

According to a further aspect there is provided a method of providing a clock signal to a sub-system of a processor, the method comprising: receiving, at a first clock selection stage, clock signals from a plurality of clock sources; providing, from the first clock selection stage, first and second clock signals to a second selection stage responsive to one or more first control signals; selecting, at the second clock selection stage, one of the first and second clock signals responsive to one or more second control signals; outputting, from the second selection stage, the selected clock signal as a mitigated clock signal. In an embodiment the method may further comprise: receiving, at a modulator stage, the mitigated clock signal; modulating, at a modulator unit of the modulator stage, the mitigated clock signal responsive to one or more modulation signals; providing, from the modulator unit, the modulated clock signal to the subsystem. Providing the modulated clock signal to the subsystem may comprise providing the modulated clock signal to a processor core of a multi-core system.

The method may include functioning steps of any of the components discussed with reference to the first aspect.

According to a further aspect, there is provided a system comprising: the above circuitry, implemented in at least one packaged chip; at least one system component; and a board, wherein the at least one packaged chip and the at least one system component are assembled on the board.

According to a further aspect, there is provided a chip-containing product comprising the above system assembled on a further board with at least one other product component.

According to a further aspect, there is provided a non-transitory computer-readable medium to store computer-readable code for fabrication of the above circuitry.

### BRIEF DESCRIPTION OF THE DRAWINGS

Embodiments of the present techniques will now be described by way of example only and with reference to the accompanying drawings, in which:

FIG. 1 schematically shows a diagram of a system having a clock control circuit;

FIG. 2 schematically shows a diagram of the clock control circuit of the system of FIG. 1 in more detail;

FIG. 3 schematically shows domains of the clock control circuit of FIG. 1;

FIG. 4 schematically shows a simplified flow diagram of a method of operation of a system comprising according to one implementation of the present techniques; and

FIG. 5 illustrates a system and a chip-containing product.

### DETAILED DESCRIPTION

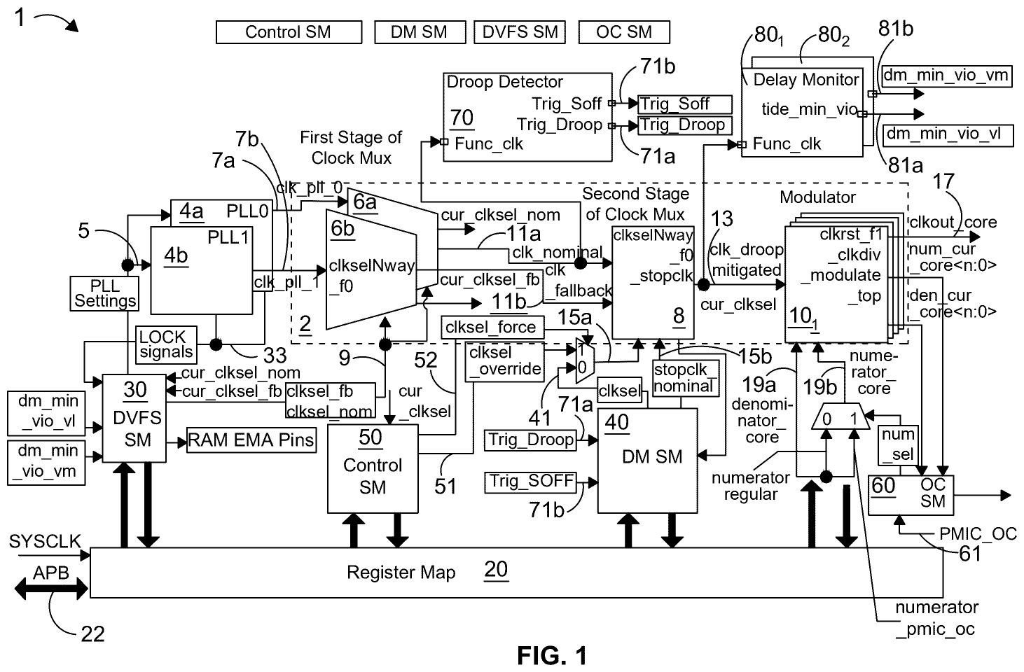

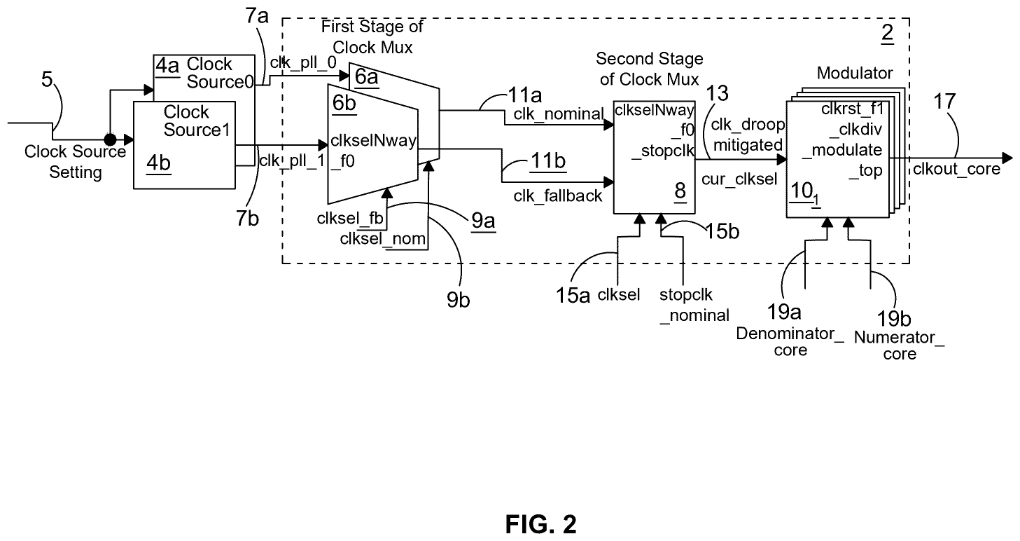

FIG. 1 schematically shows a diagram of a circuit system 1 (e.g. of a system on chip) having a clock control circuit 2 and where FIG. 2 schematically shows features of the clock control circuit 2 in more detail.

It will be appreciated that the term “signal” is non-limiting and may take any form to convey a message, operation or information to a component (hardware or software), where, for example, the signal may comprise one or more bits, a logic value (e.g. high or low), or a voltage value etc. In embodiments the signal may comprise a clock signal having a particular frequency and or level (e.g. voltage level).

Furthermore, the signals provided to a component (e.g. hardware or software) to control the operation thereof (E.g. to select a particular clock signal) or to change properties thereof (e.g. to cause the component to operate in a certain way) may be referred to as a “control signal.”

In the present example, the control signals provided to the clock control circuit 2 may be provided from circuitry comprising (e.g. configured to operate as) state machines 30, 40, 50, 60 as will be described in detail below. Furthermore, clock signals may be provided to clock pins of the components of the clock control circuit 2. The clock control circuit 2 and clock sources and other state machines 30, 40, 50, 60 are taken to operate as a clock control state machine (CCSM).

The state machines may be implemented as hardware and/or software. In embodiments, the state machines are implemented as fixed function hardware.

The state machines may access, for example, storage to generate the signals to control the clock control circuit 2 (or other state machines) in response to the data/values (e.g. one or more bits) therein. In the present illustrative example, the storage comprises a plurality of registers, where one or more of the registers may be programmable.

The state machines may access (read and/or write) registers of register map 20 as required for a particular operation. The register map 20 may be accessed by components of the system 1.

The registers may also be accessed by, for example, firmware (e.g. during start-up), where the firmware may access the registers, for example, via an interface such as an Advanced Peripheral Bus (APB), which may be part of the Advanced Microcontroller Bus Architecture (AMBA) protocol family, although the claims are not limited in this respect.

Clock control circuit 2 receives a plurality of clock signals from clock sources 4n (where “n” is an integer, n>1), where clock source₀ 4a & clock source₁ 4b, are shown in FIGS. 1-3.

In the present embodiment the clock sources 4a & 4b are phased locked loops (PLL), where each clock source provides a clock signal having a voltage and frequency.

However, the claims are not limited to the clock sources being PLL and in a further embodiment the clock source 4b may be a derivative of clock source 4a. For example, the clock source 4b may be a divided clock of the first clock source 4a. In a still further embodiment the first and second clock sources 4a & 4b may be fixed clock sources from different units.

In the present embodiment, where the clock sources 4a & 4b are PLLs, each clock source 4a/4b receives one or more PLL signals 5 to configure the properties of the clock signals and supplies the clock signal 7a, 7b to the clock control circuit 2.

In the present illustrative example, a Dynamic Voltage and Frequency Scaling (DVFS) state machine 30 provides the PLL signals 5. The properties of the PLL signals may be set in response to requests from the control state machine 50 dependent, for example, where a request from control state machine may request the DVFS state machine 30 to, for example, perform a set of tasks that are required to configure the PLL in accordance with a DVFS sequence.

Furthermore, the control state machine 30 may send requests to the DVFS state machine 30 to increase or decrease a target voltage/operating point (OPP) dependent on an existing OPP (e.g. as defined in one or more registers).

The control state machine 50 may also request the DVFS state machine to perform other tasks such as, for example, to configure a RAM (Random access memory) EMA (extra margin adjustment), where the DVFS state machine 30 drives the EMA related pins of the RAM, and where the RAM pin states are dependent on, for example, the type of bitcell, memory architecture and the voltage of operation.

The clock control circuit 2 comprises a first clock path stage comprising multiplexers 6a, 6b, which are controlled, responsive to clock select signal 9 (depicted as clksel_nom or clksel_fb in FIGS. 1-3), to cause the first stage to supply a first clock signal 11a which is designated as a nominal clock signal (depicted as clk_nominal) and to supply a second clock signal 11b which is designated as a fallback clock signal (depicted as clk_fallback) to a second clock path stage 8.

The nominal clock signal 11a comprises a relatively high frequency fast clock that may be provided to a sub-system which may comprise digital logic such as a processor (e.g. CPU or GPU) sub-system (e.g. core) or cellular baseband logic. The fallback clock signal 11a is a relatively low frequency slow clock that may be used when an event (e.g. a droop event) is detected.

In the present illustrative example, the DVFS state machine 30 provides the clock select signal 9 to drive the nominal clock signal or the fallback clock signal to the second clock path stage dependent on, for example, whether an event (e.g. a droop event) is detected. Since the effects of droop are more severe at higher clock frequencies and higher clock voltages, the fallback clock signal, which is to be selected by the clock mux during droop events, has a lower frequency than the nominal clock signal. In an example, the nominal clock signal has a frequency of 3.5 GHZ and the fallback clock signal has a frequency of 3.4 GHZ.

The second clock path stage 8 provides a clock signal 13 to a modulator stage, where the modulator stage comprises a plurality of modulator units 10₁-10ₘ (where “m” is an integer).

In the present example the clock signal 13 is provided from the second clock path stage 8 responsive to signals 15a/15b, where the signals 15a/15b may be provided in accordance with a droop mitigation scheme. Such a droop mitigation scheme may mitigate against the negative effects of voltage droop. In this sense, the output of the clock circuit is taken to be a mitigated clock signal (depicted as clk_droop_mitigated).

In the present illustrative example, the signals 15a/15b are provided by a droop mitigation state machine 40 and a control state machine 50 dependent on the properties of a droop event.

For example, the droop mitigation state machine 40 and control state machine 50 are used to provide a clock control signal 15a to cause the second clock path stage 8 to select and provide the nominal clock signal 11a or the fallback clock signal 11b to the modulator stage as the mitigated clock signal 13. For example, the droop mitigation state machine 40 is to provide a “clksel” signal 41 which is to cause the second stage 8 to provide either the nominal clock signal 11a or the fallback clock signal 11b to the modulator stage depending on the value of the “clksel” signal 41, and where the control state machine 50 is to provide a “clksel_override” signal 51 which is to override the clksel signal 41, where one of the clksel signal 41 or clksel_override 51 are selected in response to a clksel_force signal 52, which in the present illustrative example is used to control a multiplexer to select between the signals 41 and 51.

Furthermore, the droop mitigation state machine 40 is to provide signal 15b to prevent any clock signal to be provided to the modulator stage on detection and for the duration of a particular event (e.g. a droop event).

The modulator units 10₁-10ₘ each modulate the mitigated clock signal 13 (e.g. using average power modulation) and provide, responsive to modulator signals 19a/19b the modulated clock signal 17 to a particular sub-system (e.g. a core (not shown)) of a processor unit (not shown) or other digital logic.

The modulator units 10₁-10ₘ may operate independently of each other, so as to, for example, independently provide average power modulation per core of a multi-core system. In the present illustrative example, the clock control circuit 2 comprises a modulator unit 10ₘ per core (not shown))

The modulator units 10₁-10ₘ may be individually selected and/or the settings thereof may be controlled responsive to modulator control signals (hereafter “modulator signal(s)”, “control signal” or “signal(s)”). The modulator signals 19a/19b may be used to select the modulator unit 10₁ to 10ₘ which is used to modulate the mitigated clock signal 13 and/or to identify the sub-system to which the clock signal 17 is to be provided. The modulator signals 19a/19b may also define how the modulator is to modulate the mitigated clock signal 13. In the present illustrative example, the modulator signal 19a comprises a denominator value which may be obtained from a register (e.g. via register map 20). The modulator signal 19b comprises a numerator value (e.g. depicted as numerator_regular or numerator_pmic_oc), which may be obtained from registers. In the present illustrative embodiment, the fraction of clock pulses present in the output clock signal 17 relative to the mitigated clock signal are taken to be the numerator/denominator.

The values of the numerator and denominator can be programmed independently for each modulator unit and stored in the programmable register(s) of register map 20 where the modulator uses to the numerator and denominator values to modify the mitigated clock signal 13 (e.g. to supress the frequency) to provide the output clock signal 17.

For example, the denominator value may define how many clock cycles of the mitigated clock signal are to be output. As a further example, the numerator value may define how many clock cycles of the mitigated clock signal are to be suppressed.

In the present illustrative example, modulator signal 19b may be selected to be numerator_pmic_oc by an over-current state machine 60, where the over-current state machine 60 provides hardware support for current demand reduction, for example, in the case of a signal 61 (e.g. a warning signal (e.g. a pre-over-current signal)) from a Power Management IC (PMIC) (not shown).

As an illustrative example, the over-current state machine 60 receives warning signal 61 and asserts modulator signal 19b to be ‘numerator_pmic_oc’ as opposed to ‘numerator_regular’ when the warning signal 61 is received from the power management PMIC, where the numerator_pmic_oc value changes the modulator settings to provide a modulated clock signal 17 which reduces the current demand by a sub-system (not-shown) receiving the modulated clock signal 17 in comparison to ‘numerator_regular’ value for the numerator.

In embodiments the modulator units 10₁-10ₘ may modify the mitigated clock signal 13 by suppress one or more clock pulses of the mitigated clock signal to change the frequency thereof e.g. to reduce the current demand of the sub-system. As an illustrative example, when every 2^{nd} clock pulse of the mitigated clock signal is suppressed the frequency of the resulting modulated clock signal 17 will reduced by 50% compared to the frequency of the mitigated clock signal.

As described above the state machines 30, 40, 50 and/or 60 may access values/data in registers of register map 20 to generate the control signals to control the clock control circuit 2 (or other state machines) in response to the data/values (e.g. one or more bits) therein.

In the present illustrative example, values/data in registers of the register map 20 can be used to configure the settings of state machines in the programmable registers.

Examples what the data/values in the registers in the present illustrative embodiments include, but are not limited, to define:
architectural level inputs for the nominal PLL (or clock source);
a bit(s) for enabling the nominal PLL (or clock source);
settings for the clock generator that drives the nominal frequency;
architectural level inputs for the fallback PLL (or clock source);
the settings for the clock generator that drives the fallback frequency;
timer that runs on SYSCLK. It is used to ascertain voltage stability for both the memory and the logic supply;
a strategy that CCSM uses to determine voltage stability;
a strategy for droop mitigation;
whether a mitigation strategy is enabled;
the mitigation strategy on a droop event;
overrides the existing droop mitigation of stopping the clock during a DVFS transition;
the settings of the Modulator;
the value of the denominator of the Modulator;
the value of the numerator of the Modulator in regular use case;
the value of the numerator of the Modulator when there is a pre-over-current warning from the PMIC;

It will be appreciated that the above examples of data/values in the registers are not exhaustive and are for illustrative purposes only.

As described above, the various state machines 30, 40, 50, 60 may interact and influence the control and/or clock signals generated by one another.

Additionally, or alternatively, the system 1 may comprise further components (hardware and/or software components) that may interface with the various state machines 30, 40, 50, 60 and vice versa to influence the control and/or clock signals generated thereby. For example, the various state machines of the CCSM may interface with droop detectors or delay monitors to carry out droop mitigation and DVFS.

As an illustrative example, system 1 comprises one or more droop detectors 70, one of which is depicted in FIG. 1.

In the present illustrative example, droop detector 70 receives the nominal clock signal 11a and is configured to monitor (e.g. continuously monitor) the nominal clock signal 11a for a voltage droop event. For example, the droop detector 70 may compare the voltage of the nominal clock signal 11a with one or more thresholds (e.g. stored in a register). The droop detector 11 identifies a droop event when the voltage of the nominal clock signal 11a falls below a threshold. On detection of a droop event, the droop detector 70 outputs droop trigger signals, depicted in FIG. 1 as droop trigger signals 71a (TRIG_DROOP) & 71b (TRIG_SOFF).

The droop trigger signals are used as inputs to droop mitigation state machine 40 which may, in response to the signals, control which of signals 15a/15b are provided to the second clock path stage 8 and thereby control the mitigated clock signal 13 provided to the modulator units 10₁-10ₘ of the modulator stage in accordance with, for example the register values defining in the droop mitigation strategy.

As a further illustrative example, system 1 comprises one or more delay monitors 80, two of which 80₁ & 80₂ are depicted in FIG. 1. The delay monitors 80 may be located in different locations (e.g. cores, storage etc.) of a processor (e.g. CPU or GPU), with each delay monitor to measure the delays e.g. in a clock cycle of a clock supplied to components at the respective locations.

The delay monitors 80₁ & 80₂ receive the mitigated clock signal 13 and in response to an event (e.g. a delay in the clock signal vs an expected delay), the delay monitor that detects the delay event generates a violation signal, where delay monitor 80₁ generates violation signal 81a and delay monitor 80₂ generates violation signal 81b. In the present illustrative example, the violation signal 81a (depicted as (dm_min_vio_vl) comprises a delay monitor violation signal for logic supply and the violation signal 82a depicted as (dm_min_vio_vm) comprises a delay monitor violation signal for memory bitcell supply. However, it will be appreciated that the claims are not limited in this respect, and delay monitors may be provided to generate violation signals for may different areas of a processor (e.g. CPU/GPU sub-system).

The violation signals are used as inputs to DVFS state machine 30 to, for example, calibrate DVFS setpoints, manage DVFS transitions and/or to allow the DVFS state machine to check for voltage stability while performing transitions.

The present techniques provide for a clock control circuit system 1 (e.g. of a system on chip) having a clock control circuit having a plurality of clock sources, where the system can be configured to provide a clock for, for example, one or more cores of a processor system (e.g. a CPU or GPU).

The system comprises various components (e.g. software and/or hardware) which are configured to operate as a CCSM to perform multiple functions such as:
Configuring one or more clock sources, for instance PLL clock sources;
Enabling fast switching between DVFS modes;
Providing support (e.g. hardware support) for droop mitigation (E.g. to reduce voltage margining for timing sign-off to decrease power for a given frequency of operation);
Providing hardware support for reducing current consumption (e.g. in the case of a pre-over-current warning from a PMIC).

The different components may be mapped to different voltage domains, with different state machines in different domains, where components in different voltage domains may or may not undergo a voltage change during a DVFS sequence executed by the CCSM.

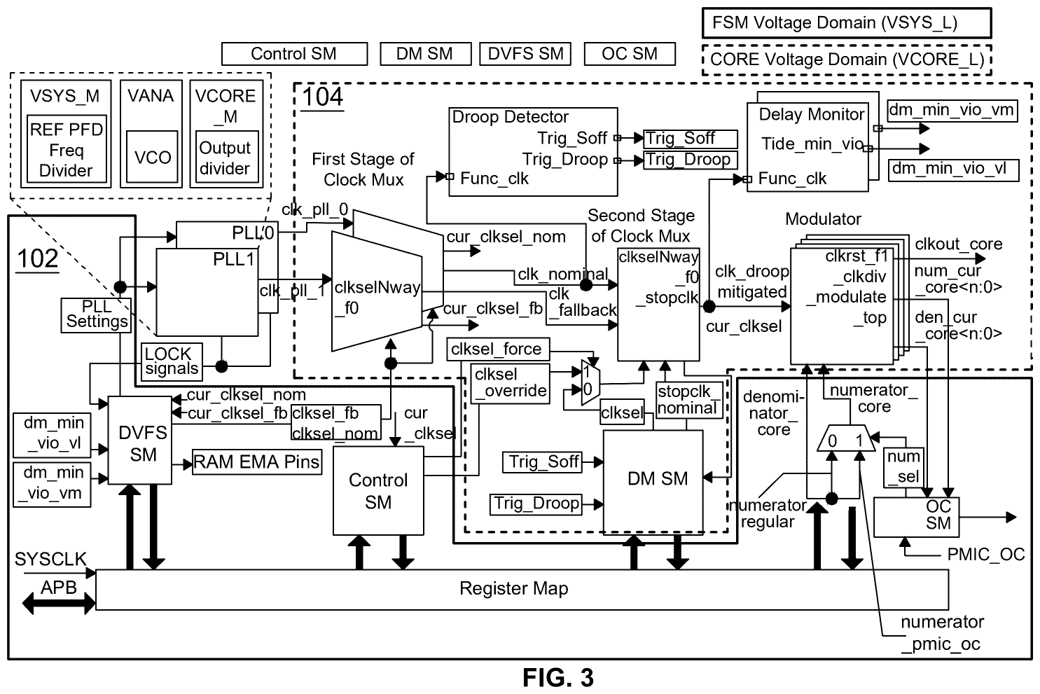

FIG. 3 schematically shows example voltage domains for the system 1 of FIG. 1, where the voltage domain 102 (depicted as VSYS_L) does not undergo a voltage change during a DVFS operation or sequence executed by the CCSM, and where voltage domain 104 (depicted as VCORE_L) is used for the clock logic after the clock is tapped from the PLL clock sources 4a/4b, and does undergo a voltage change during a DVFS operation or sequence executed by the CCSM.

As depicted in FIG. 3, the clock control circuit 2 is entirely within the voltage domain 104. Thus the first and second stages are also within the voltage domain 104. The droop mitigation state machine 40 is also within the voltage domain 104.

The remaining state machines depicted in FIG. 1 (i.e. DVFS state machine 30; control state machine 50 and over current state machine 60) are within the voltage domain 102.

In some cases control signals generated by a state machine or circuitry in a first voltage domain and provided to a state machine or circuitry of a second voltage domain may require to be level-shifted from the voltage of the first domain to that of the second domain.

As an illustrative example, the DFVS state machine 30 is in voltage domain 102 so the control pins of the first stage of clock mux are in the voltage domain 102.

Consequently, the signals generated from the voltage domain 102 need to be level-shifted to the voltage domain 104. Similarly, the outputs of the clock mux must be shifted back to the voltage domain 102 before they are used by the DVFS State Machine 30. Additionally, the DVFS state machine 30 takes inputs from the Delay Monitor 80n, which is on the voltage domain 104 so must also be shifted to voltage domain 102.

The Control State Machine and the interrupts (err_irq_control, err_irq and status_irq) are on voltage domain 102.

The Droop Mitigation State Machine uses voltage domain 102. It takes inputs from Droop Detector, which also uses voltage domain 104.

The PMIC_OC signal is on the voltage domain 102. The interrupt err_irq_oc is on voltage domain 102.

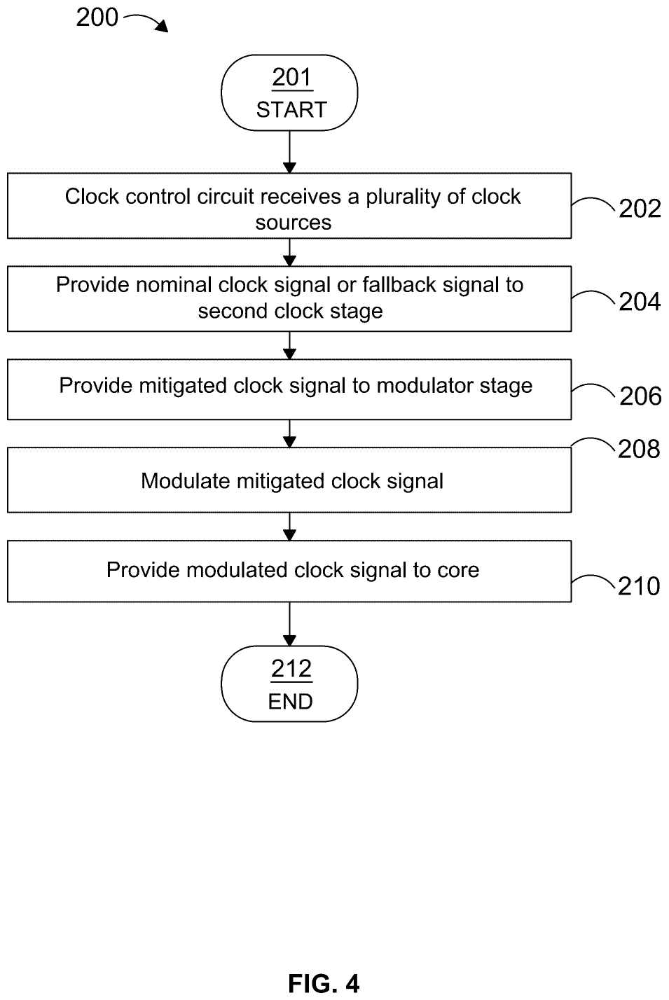

Turning now to FIG. 4, there is shown a simplified flow diagram of a method 200 of operation a clock control circuit of the CCSM according to one implementation of the present techniques.

An instance of the method starts at 201.

At S202 a first clock path stage of the clock control circuit receives a plurality of clock sources, which in the present embodiment are phased locked loops (PLL), where each clock source provides a clock signal having a voltage and frequency. DVFS state machine provides signals to configure the properties of the clock sources.

At S204 the first clock path stage, responsive to a clock select signal, supplies a first clock signal (nominal clock signal) or a second clock signal (fallback clock signal) to a second clock path stage. The nominal clock signal comprises a relatively high frequency fast clock that may be provided to a processor (e.g. CPU or GPU) sub-system. The fallback clock signal is a lower frequency clock relative to the nominal clock.

At S206, the second clock path stage provides a mitigated clock signal to modulator units of a modulator stage, where the clock signal is provided from the second clock path stage responsive to control signals provided from a state machine in accordance with a droop mitigation scheme. For example, droop mitigation state machine and control state machine are used to provide control signal(s) to cause the second clock path stage to provide the nominal clock signal or the fallback clock signal to the modulator stage as the mitigated clock signal dependent on whether an event is detected (e.g. a droop event).

At S208, the modulator units of the modulator stage modulate the mitigated clock signal responsive to modulator control settings (e.g. using average power modulation) and, at S210, each modulator unit may provide the modulated clock signal to a particular sub-system of a processor unit (not shown) as an output clock. In embodiments the modulator units each provide a modulated clock signal to a respective core of the processor unit. As described above the CCSM and other state machines thereof may access values/data in registers of register map to generate the signals to control the clock control circuit (or other state machines) in response to the data/values (e.g. one or more bits) therein.

At S212 the process ends.

The method performed by the CCSM (and components thereof) provide for:
Configuring one or more clock sources, for instance PLL clock sources;
Enabling fast switching between DVFS modes;
Providing support (e.g. hardware support) for droop mitigation (E.g. to reduce voltage margining for timing sign-off to decrease power for a given frequency of operation);
Providing hardware support for reducing current consumption (e.g. in the case of a pre-over-current warning from a PMIC).

The embodiments above in FIGS. 1-4 depict the modulator stage as outputting the modulated clock signal 17 to a particular sub-system (e.g. a core (not shown)) of a processor unit (not shown) or other digital logic. Such an arrangement may be used, for example, in embodiments where one clock source (e.g. PLL) supplies more than one core, where the modulator unit allows for, for example, throttling the clock frequency of one core but not another core.

In other embodiments where there is one clock source per core the modulator stage may be bypassed or omitted (e.g. which allows for per core DVFS). For example, an infrastructure system may comprise a number of cores (e.g. 64, 128 cores (e.g. CPU)). The OS may generate virtual machines and software may select a cluster of cores comprising a subset of the total cores (e.g. 4, 8, 16 etc.) that is required for tasks to form a virtual machine, which depends on the workload.

Depending on the configuration of voltage regulators, the cluster of cores (e.g. identically designed cores) may share a supply. Alternatively, each core may be assigned a dedicated voltage regulator (per-core DVFS). In the case of a cluster, the shared voltage determines the operating clock frequency a core can support. When cores within the cluster are assigned different workloads by the operating system with different performance requirements, a clock modulator can be added for each core. The modulator uses pulse-deletion at a programmable rate to reduce the effective power consumption of the cluster to stay within a regulator's power limit. When the regulator reaches the power limit it may issue a HW alarm signal to indicate that the regulator is over-loaded. In this case we use the OC-SM to substitute the modulator set-up to moderate power. Doing this on a per-core basis allows the system to maintain operation of essential services and control whether a workload can be terminated in case of such alarms.

In case of per-core DVFS, power conversion and clock generation are provided individually for each core. In this case the modulator unit is not needed as the power demand to the voltage regulator can be managed directly by dropping the clock frequency at the respective clock source (e.g. PLL). In this case the OC-SM may either be omitted or the OC-SM acts on the PLL divider settings rather than a modulator.

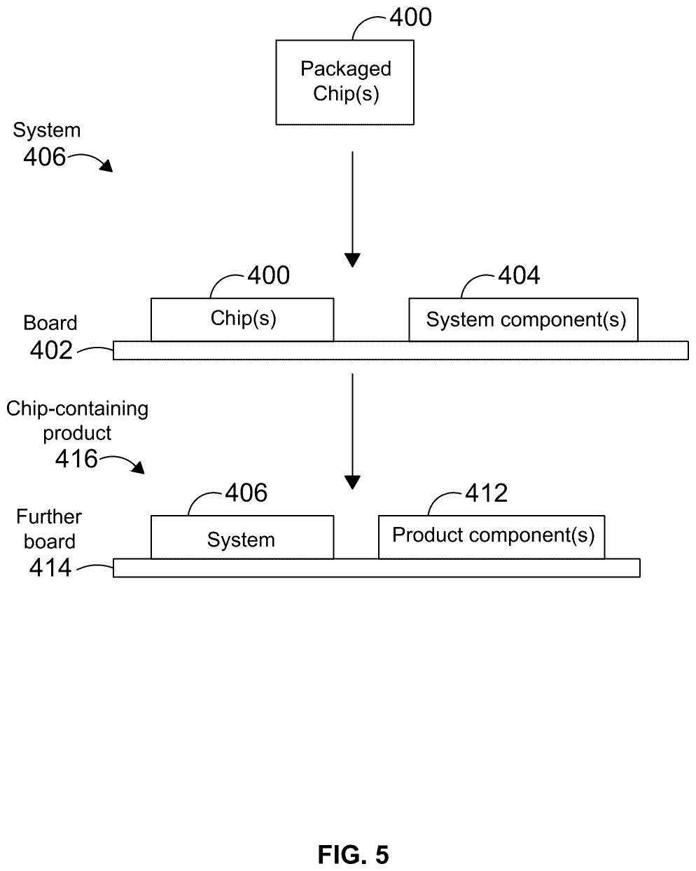

As shown in FIG. 5, one or more packaged chips 400, with the circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

As will be appreciated by one skilled in the art, the present technology may be embodied as a method, a circuit or a computer readable medium comprising data and imperatives to cause construction of a circuit. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the present techniques. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the present techniques. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the present techniques have been described in detail herein with reference to the accompanying drawings, it is to be understood that the present techniques are not limited to those precise embodiments, and that various changes and modifications can be effected therein by one skilled in the art without departing from the scope of the present techniques as defined by the appended claims.

1. Circuitry for providing a clock signal to a sub-system of a processor, the circuitry comprising:
a first clock selection stage to receive clock signals from a plurality of clock sources and, responsive to one or more first control signals, provide first and second clock signals to a second selection stage;
a second selection component at the second selection stage to, responsive to one or more second control signals, select one of the first and second clock signals and output the selected clock signal as a mitigated clock signal.

2. The circuitry of claim 1, further comprising a modulator stage to receive the mitigated clock signal;
the modulator stage comprising a plurality of modulator units to, responsive to one or more modulation signals, modulate the mitigated clock signal and provide the modulated clock signal to the subsystem.

3. The circuitry of claim 1, where the first selection component is controlled responsive to control signals from a first state machine.

4. The circuitry of claim 3, where the properties of the control signals from the first state machine are defined by a second state machine.

5. The circuitry of claim 4, where the second selection component is controlled responsive to control signals from the second and/or a third state machine.

6. The circuitry of claim 5, where the properties of the control signals from the second and/or third state machine are dependent on a detected first event.

7. The circuitry of claim 4, where the detected first event comprises a voltage droop event.

8. The circuitry of claim 1, where a modulator unit of the plurality of modulator units is operable to modulate the mitigated clock signal and provide the modulated clock signal to the subsystem responsive to modulator signals received thereat.

9. The circuitry of claim 8, where the modulator unit is to modulate the mitigated clock signal by one or more of: changing the frequency of the mitigated clock signal; and suppressing one or more of the clock pulses of the mitigated clock signal.

10. The circuitry of claim 1, where the first clock signal provided to the second selection stage comprises a nominal clock signal and where the second clock signal provided to the second selection stage comprises a fallback clock signal.

11. A state machine comprising circuitry for providing a clock signal to a sub-system of a processor, the circuitry comprising:
a first clock selection stage to receive clock signals from a plurality of clock sources and, responsive to one or more first control signals, provide first and second clock signals to a second selection stage;
a second selection component at the second selection stage to, responsive to one or more second control signals, select one of the first and second clock signals and output the selected clock signal as a mitigated clock signal.

12. The state machine of claim 11, further comprising a modulator stage comprising a plurality of modulator units and where each of the plurality of modulator units is to, responsive to one or more modulation signals, modulate the mitigated clock signal and provide the modulated clock signal to the subsystem.

13. The state machine of claim 11, further comprising a first state machine to define the properties of the one or more first control signals.

14. The state machine of claim 13, where the first state machine is to define the properties of the one or more first control signals responsive to dynamic voltage and frequency scaling operations.

15. A method of providing a clock signal to a sub-system of a processor, the method comprising:
receiving, at a first clock selection stage, clock signals from a plurality of clock sources;
providing, from the first clock selection stage, first and second clock signals to a second selection stage responsive to one or more first control signals;
selecting, at the second clock selection stage, one of the first and second clock signals responsive to one or more second control signals;
outputting, from the second selection stage, the selected clock signal as a mitigated clock signal.

16. The method of claim 15, further comprising:
receiving, at a modulator stage, the mitigated clock signal;
modulating, at a modulator unit of the modulator stage, the mitigated clock signal responsive to one or more modulation signals;
providing, from the modulator unit, the modulated clock signal to the subsystem.

17. The method of claim 15 comprising, providing the modulated clock signal to the subsystem comprises providing the modulated clock signal to a processor core of a multi-core system.

18. A system comprising:
the circuitry of claim 1, implemented in at least one packaged chip;
at least one system component; and
a board,
wherein the at least one packaged chip and the at least one system component are assembled on the board.

19. A chip-containing product comprising the system of claim 18 assembled on a further board with at least one other product component.

20. A non-transitory computer-readable medium to store computer-readable code for fabrication of the circuitry for providing a clock signal to a sub-system of a processor of claim 1.
